(19) United States
(12) Patent Application Publication
(10) Pub. No.: US 2009/0010361 A1
(43) Pub. Date: Jan. 8, 2009

(54) METHOD AND APPARATUS FOR LOCATIONING USING THE GUARD INTERVALS OF TDS-OFDM DIGITAL TELEVISION SIGNALS

(75) Inventor: LIN YANG, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/772,518

(22) Filed: Jul. 2, 2007

(51) Int. Cl. H04L 27/00

(52) U.S. Cl. 375/316

(57) ABSTRACT

A TDS-OFDM receiver for positioning using guard intervals comprising PN sequences is provided. The receiver comprises the step of calculating a transmission time of at least one PN among a plurality of PNs in a digital television (DTV) signal or information originating from a transmitter and transmitted to a mobile receiver.

### CROSS-REFERENCE TO OTHER APPLICATIONS

The following applications of common assignee are related to the present application, and are herein incorporated by reference in their entireties:

U.S. patent application Ser. No. 11/744824 to Yang, entitled “METHOD AND APPARATUS FOR DECISION FEEDBACK LOCATIONING USING DIGITAL TELEVISION SIGNALS” with attorney docket number LSFFT-064.

U.S. patent application Ser. No. 11/770,651 to Yang, entitled “METHOD AND APPARATUS FOR POSITIONING USING ATSC DIGITAL TV SIGNALS” with attorney docket number LSFFT-063.

U.S. patent application Ser. No. 11/772,477 to Yang, entitled “METHOD AND APPARATUS FOR LOCATIONING USING DVB-T DIGITAL TELEVISION SIGNALS” with attorney docket number LSFFT-065.

### FIELD OF THE INVENTION

The present invention relates generally to locationing or determining the exact location of a fixed or moving object, more specifically the present invention relates to method and apparatus for locationing using the guard intervals of TDS-OFDM digital television signals.

### BACKGROUND

Locationing using GPS signals is known.

Digital TV signals is known to be used for receiving digital programs for watching. However, digital signals are known to be used for locationing purposes. U.S. Published Patent Application No. 20070008220 to Matthew Rabinowitz et al describes an apparatus to determine the position of a user terminal, the apparatus having corresponding methods and computer-readable media, comprises a receiver to receive, at the user terminal, a wireless orthogonal frequency-division multiplexing (OFDM) signal comprising a scattered pilot signal; and a processor to determine a pseudo-range based on the scattered pilot signal; wherein a position of the user terminal is determined based on the pseudo-range and a location of a transmitter of the OFDM signal.

Using PN (pseudo-noise) as the guard interval in an OFDM is known. U.S. Pat. No. 7,072,289 to Yang et al describes a method of estimating timing of at least one of the beginning and the end of a transmitted signal segment in the presence of time delay in a signal transmission channel. Each of a sequence of signal frames is provided with a pseudo-noise (PN) m-sequences, where the PN sequences satisfy selected orthogonality and closures relations. A convolution signal is formed between a received signal and the sequence of PN segments and is subtracted from the received signal to identify the beginning and/or end of a PN segment within the received signal. PN sequences are used for timing recovery, for carrier frequency recovery, for estimation of transmission channel characteristics, for synchronization of received signal frames, and as a replacement for guard intervals in an OFDM context.

PN sequences are known and occupies sufficient bandwidth for a confident determination of transmission time between a transmitter and a receiver. Therefore, using only the PN sequences for determining positions of a receiver is achievable.

### SUMMARY OF THE INVENTION

A method and apparatus for positioning using at least one PN sequence used as guard intervals (GI) is provided.

In a time domain synchronous-orthogonal frequency division multiplexing (TDS-OFDM) system, method and apparatus for positioning using at least one PN sequence used as guard intervals (GI) is provided.

In a time domain synchronous-orthogonal frequency division multiplexing (TDS-OFDM) system, a part or the whole receiver is used for positioning using at least one PN sequence that is used as guard intervals (GI).

A method for positioning comprising the step of calculating a transmission time of at least one PN sequence among a plurality of PN sequences disposed within a digital television (DTV) signal or information originating from a transmitter and transmitted to a mobile receiver. The PN sequence is used as guard intervals.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example position locationing system in accordance with some embodiments of the invention.

FIG. 2 is an example digital television signal in accordance with some embodiments of the invention.

FIG. 3 is an example position locationing device in accordance with some embodiments of the invention.

FIG. 4 is an example of a flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to positioning for positioning using at least one PN sequence used as guard intervals. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of positioning using at least one PN sequence used as guard intervals. The non-processor circuits may include, but are not limited to, a radio receiver, a radio transmitter, signal drivers, clock circuits, power source circuits, and user input devices. As such, these functions may be interpreted as steps of a method to perform positioning using at least one PN sequence used as guard intervals. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention uses existing components of an exiting TDS-OFDM receiver whenever practicable. The present invention contemplates the positioning actions in a Chinese digital video broadcast schemes such as TDS-OFDM.

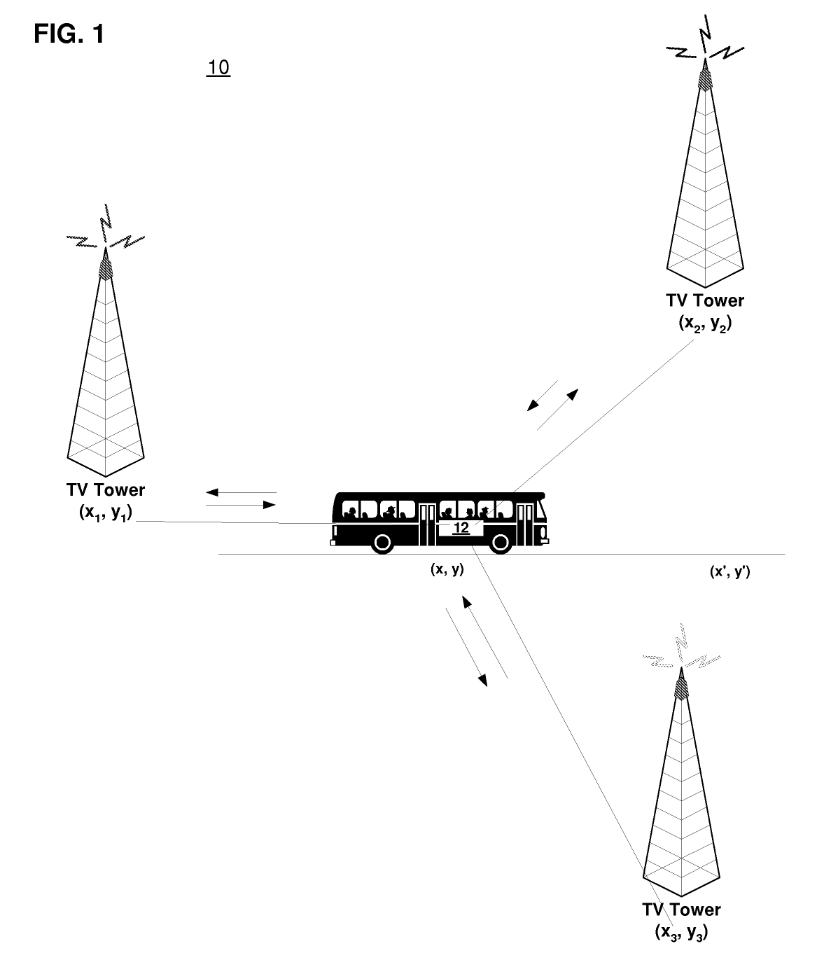

Referring to FIGS. 1-4, depictions of the present invention are shown. A positioning system 4 using known digital television (DTV) signals such as pilot signals is shown. Three DTV transmitters are provided with each transmitting at least a sufficient number of pilot signals suitable for a positioning. They are respectively: transmitter tower 1 having a predetermined position of (x₁, y₁); transmitter tower 2 having a predetermined position of (x₂, y₂); and transmitter tower 3 having a predetermined position of (x₃, y₃). A moving object 6 such as a moving vehicle having users carrying hand held devices is provided. The hand held devices comprise at least part of a DTV receiver. Moving object 6 has a variable position (x, y). The positioning of moving object 6 comprises determine the position (x, y) at time t. Typically, the distance d₁ is defined as the distance between (x₁, y₁) and (x, y). Similarly, d₂ is defined as the distance between (x₂, y₂) and (x, y); as well as d₃ being the distance between (x₃, y₃) and (x, y). As can be seen, when moving object 6 moves to a new point (x′, y′), distances between (x₁, y₁) and (x′, y′) changes. Similarly, new d₂ and d₃ need to be derived. Using the three towers each having known position to derive a positioning of moving object 6 is shown in detail in FIG. 3. Once the distance is known, the positioning of moving object 6 can be derived using any type of positioning in a known manner such as triangulation, etc.

As can be seen, only a two dimensional (2D) scheme is shown. However, the present invention contemplates a three dimensional (3D) scheme as well by introducing a third variable z such that d₁-d₃ is define on a 3D co-ordinate or space with d₁ being the distance between (x₁, y₁, z₁) and (x, y, z). Similarly, d₂ is defined as the distance between (x₂, y₂, z₂) and (x, y, z); and d₃ is defined as the distance between (x₃, y₃, z₃) and (x, y, z).

It is noted that unknown data segments are so referred because a mobile receiver does not know the various parameter including timing or clock info related therewith. For example, data segments or part of a DTV program information may constantly change. Therefore, data segments are unknown as compared to pilot signals that are known. In addition, unknown data segments typically occupy more space or takes more time than a typical pilot signal as the purpose of the DTV information is for a viewer to watch DTV programs which comprises virtually all of the unknown data segments. The present invention contemplates the use of only known signals such as pilot signals. The present invention does not use unknown signals.

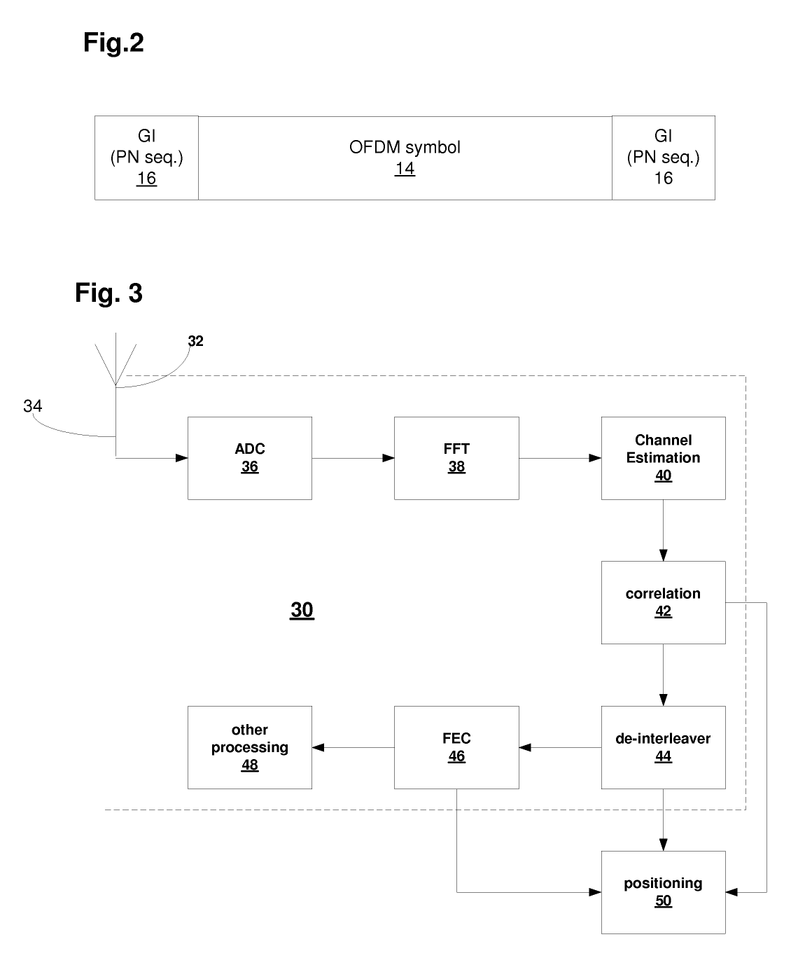

In FIG. 2, a depiction of a part of a frame in an OFDM communication systems having unknown OFDM symbols 14 and a plurality of pilot signals 16 is provided. The unknown OFDM symbols 14 comprise the information adapted to carry TV programming information. Pilot signals 16 are known signals that are used for positioning.

Referring now to FIG. 3, a block diagram 30 of at least part of a receiver is shown. In a TDS-OFDM receiver 30, an antenna 32 receives wireless signals including guard interval (GI) 16, but only the guard intervals having the PN sequences are used. The received signal 34 is subjected to a front-end ADC 36 such that the analog RF signal may be converted to base-band and transformed into a digital signal, using an analog-to-digital converter (ADC). In turn, Fast Fourier transform 38 transformed the digital information into a different domain. The transformed information is subjected to channel estimation 40 and correlation block 42. The correlated information is sent to a time de-interleaver 44 and then to the forward error correction block 46. At this juncture, various actions may be performed including use the restored PN sequence for positioning purposes. The derived symbol or data signal are subject to a typical processing 48 by a typical TDS-OFDM receiver and are utilized by the present invention. As can be seen, only the restored PN sequence is used for positioning purposes. Another action is using the restored PN for positioning 50. Depending upon specific structures of a TDS-OFDM receiver, varies points therein may be used for positioning purposes. In other words, information from various points may be utilized by block 50 for positioning. In block 50, information is used for positioning in that the restored known PN sequence or guard interval can be used to determine a timing difference. In other words, the actual measurement of travel time between a base station (e.g. TV tower 1) and a mobile station (e.g. mobile device 12) can be achieved.

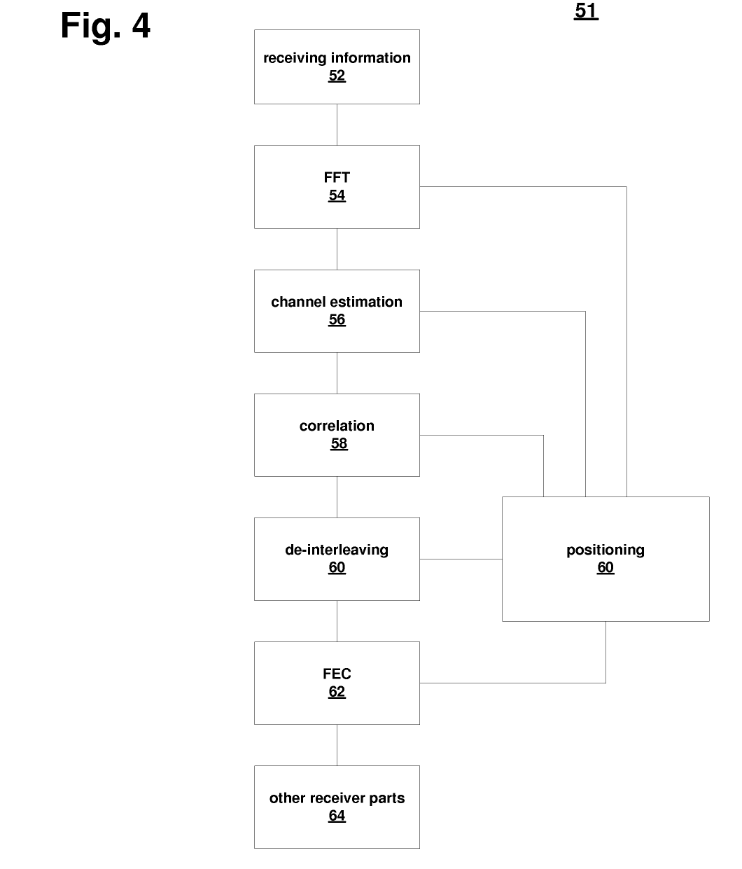

Referring to FIG. 4, a flowchart 51 of the present invention is shown. Flowchart 51 depicts a method for positioning comprising the step of calculating a transmission time of at least one PN guard interval among a plurality of PN guard intervals disposed within a signal or information originating from a transmitter and transmitted to a mobile receiver. The transmitter comprises a TDS-OFDM transmitter. Initially, a receiving side that may be part of a known receiver receives information including at least one PN guard interval among a plurality of PN guard intervals of the television signal disposed within the transmitted information (Step 52). The received at least one PN guard interval is subject to a transformation such as Fast Fourier Transform or FFT (Step 54). The transformed information including the least one guard interval PN sequence is subject to channel estimation (Step 56). The estimated PN, in turn, is subjected to correlation (Step 58). The correlated PN is used for de-interleaving (Step 60). The de-interleaved PN is used for forward error control (FEC) Step 62. After FEC, the information is subject to further process according to a typical TDS-OFDM receiver (Step 64). At various points (only five shown) in the above process, information may be used for positioning (Step 66) whenever practicable as described herein this invention.

By way of an example, the PN GI is used for positioning purposes in block 50 may be as follows. At least one restored PN sequence 16 of FIG. 2 is used for the processing of a positioning system. The distances d₁, d₂, and d₃ or the value of (x, y, z) may be measured as follows. By receiving from the 3 TV transmitters TV signals, a time offset between a local clock of that TV transmitter and a reference clock is established. The reference clock may be derived from GPS signals. The use of a reference clock permits the determination of the time offset for each TV transmitter when multiple monitor units (only one shown) are used. Because each monitor unit can determine the time offset with respect to the reference clock, the offsets in the local clocks of the monitor units do not affect these determinations. Alternatively, no external time reference is needed. According to this implementation, a single monitor unit receives TV signals from all three TV transmitters. The single monitor is a built-in device within a user terminal. In effect, the local clock of the single monitor unit functions as the time reference. The single monitor unit and the user terminal are combined as a single unit. Other actions of the receiver such as OFDM demodulation, demapping, internal deinterleaving, internal decoding such as using the Viterbi algorithm, external deinterleaving, and external decoding may not be need for positioning purposes.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for positioning comprising the step of calculating a transmission time of at least one PN sequence among a plurality of PN sequences disposed within a digital television (DTV) signal or information originating from a transmitter and transmitted to a mobile receiver.

2. The method of claim 1, wherein the at least one PN sequence is a guard interval between data information.

3. The method of claim 1, wherein the mobile receiver comprises a TDS-OFDM receiver.

4. An apparatus for positioning comprising a method therein comprising the step of calculating a transmission time of at least one PN sequence among a plurality of PN sequences disposed within a digital television (DTV) signal or information originating from a transmitter and transmitted to a mobile receiver.

5. The apparatus of claim 4, wherein the at least one PN sequence is a guard interval between data information.

6. The apparatus of claim 4, wherein the mobile receiver comprises a TDS-OFDM receiver.
